(19) United States
(12) Patent Application Publication
(10) Pub. No.: US 2026/0262873 A1
(43) Pub. Date: Sep. 10, 2026

(54) APPARATUS FOR PREPARING AND DELIVERING SUSTOM-ORDERED CAFFEINATED BEVERAGES

(71) Applicant: COFU LLC, Richardson, TX (US)

(72) Inventors: Philip R. McKee, Dallas, TX (US); Lee VanLanen, McKinney, TX (US)

(73) Assignee: COFU LLC, Richardson, TX (US)

(21) Appl. No.: 19/658,564

(22) Filed: Apr. 26, 2026

Related U.S. Application Data
(63) Continuation-in-part of application No. 18/099,485, filed on Jan. 20, 2023.
(63) Continuation-in-part of application No. 18/956,040, filed on Nov. 22, 2024, now Pat. No. 12,630,409.

(51) Int. Cl. A47J 31/52; A47J 31/60; B08B 5/02; B23K 26/352; B41J 2/44; B41J 3/01; B41J 29/12; B41J 29/17; B65G 47/00; G06K 19/06

(52) U.S. Cl. CPC A47J 31/52; A47J 31/60; B08B 5/02; B23K 26/352; B41J 2/442; B41J 3/01; B41J 29/12; B41J 29/17; B65G 47/00; G06K 19/06121

(57) ABSTRACT

An apparatus for preparing custom-ordered beverages is disclosed. The apparatus includes cup dispensers, beverage dispensing systems having dispensing heads, two cup-transfer mechanisms, a pick-up station, and a disposal bin. The pick-up station includes a conveyer and a set of beverage pick-up windows. The first cup-transfer mechanism transports a cup from a cup dispenser to a dispensing head to fill the cup with beverage. The second cup-transfer mechanism transports the cup with filled beverage to the pick-up station. A conveyer at the pick-up stations moves the cup with filled beverage and stops to present it at each of the beverage pick-up windows at the pick-up station. If a customer does not pick the cup within an allocated amount of time, it will be dropped into the disposal bin.

### CROSS-REFERENCE TO RELATED APPLICATIONS

The present application claims the priority of U.S. patent application Ser. No. 18/105,474, filed on Feb. 3, 2023, and the priority of U.S. patent application Ser. No. 18/956,040, filed on Nov. 22, 2024, the contents of which are incorporated herein by reference in their entirety.

### TECHNICAL FIELD

The present application relates to beverage preparation and delivery machines in general, and, in particular, to an apparatus for preparing and delivering custom-ordered caffeinated beverages.

### BACKGROUND

Upscale retail coffee shops can typically offer a wide range of freshly made hot beverages for their customers. For example, a customer may order an iced coffee made from freshly ground beans selected by the customer, then brewed to order before ice is added. These made-to-order beverage offerings typically require a wide range of equipment and skilled personnel to operate. In addition, it is relatively time-consuming to prepare made-to-order beverages. Many customers desire made-to-order beverages, but they typically do not like the long wait time for the beverages to be prepared.

Consequently, it would be desirable to provide an improved beverage preparation and delivery apparatus that overcomes the above-identified problems.

### SUMMARY OF THE INVENTION

In accordance with a preferred embodiment, an apparatus for preparing and delivering custom-ordered caffeinated beverages includes a housing containing a set of cup dispensers, various beverage dispensing systems having their respective dispensing heads, two cup-transfer mechanisms, a pick-up station, and a disposal bin. The pick-up station includes a conveyer and a set of beverage pick-up windows. The first cup-transfer mechanism transports a cup from one of the cup dispensers to one of the dispensing heads to fill the cup with beverage. The second cup-transfer mechanism transports the cup contained with filled beverage to the pick-up station. A conveyer at the pick-up station moves the cup with filled beverage and stops to present it at each pick-up window at the pick-up station. If a customer does not pick the cup with filled beverage within an allocated amount of time, the cup with filled beverage will be dropped into the disposal bin located near the conveyor.

The apparatus also includes a self-cleaning subsystem such that it is capable of being self-cleaned automatically at a predetermined time of the day without human intervention.

All features and advantages of the present invention will become apparent in the following detailed written description.

### BRIEF DESCRIPTION OF THE DRAWINGS

The invention itself, as well as a preferred mode of use, further objects, and advantages thereof, will best be understood by reference to the following detailed description of an illustrative embodiment when read in conjunction with the accompanying drawings, wherein:

FIG. 1 is a front view of an apparatus for preparing and delivering custom-ordered caffeinated beverages, in accordance with one embodiment of the present invention;

FIG. 2 depicts a conveyor for conveying completed beverages within the apparatus from FIG. 1;

FIG. 3 illustrates multiple cup turrets within the apparatus from FIG. 1;

FIG. 4 depicts various beverage dispensing systems within the apparatus from FIG. 1;

FIGS. 4A-4B depict a milk dispensing system within the apparatus from FIG. 1;

FIGS. 4C-4D depict a self-cleaning subsystem for the milk dispensing system from FIGS. 4A-4B;

FIG. 5 depicts first and second cup-transfer mechanisms within the apparatus from FIG. 1;

FIG. 5A-5B illustrate how a plunger works within the first cup-transfer mechanism;

FIG. 6A-6C illustrate the transfer of a cup from the first cup-transfer mechanism to the second cup transfer mechanism;

FIG. 6D-6F illustrates the transfer of a cup from the second cup transfer mechanism to the conveyer in FIG. 2;

FIG. 7 illustrates an exemplary screen showing the progress of a beverage order that is currently being prepared; and

FIG. 8 illustrates an exemplary screen showing an order queue and the customers' orders that are ready to be picked up at corresponding pick-up windows.

### DETAILED DESCRIPTION OF A PREFERRED EMBODIMENT

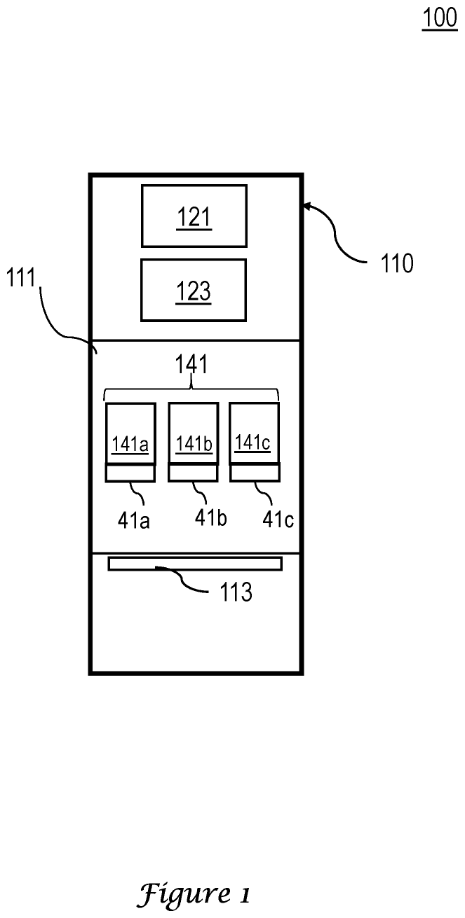

Referring now to the drawings and in particular to FIG. 1, there is depicted an apparatus for preparing and delivering custom-ordered caffeinated beverages, in accordance with one embodiment. As shown, an apparatus 100 includes a housing 110 measuring approximately 3 feet wide, 3 feet deep, and 7 feet tall. Housing 110 includes a front door 111 having an order progress display 121 and an ordering panel 123. Order progress display 121 and ordering panel 123 are preferably implemented with touch-screen displays.

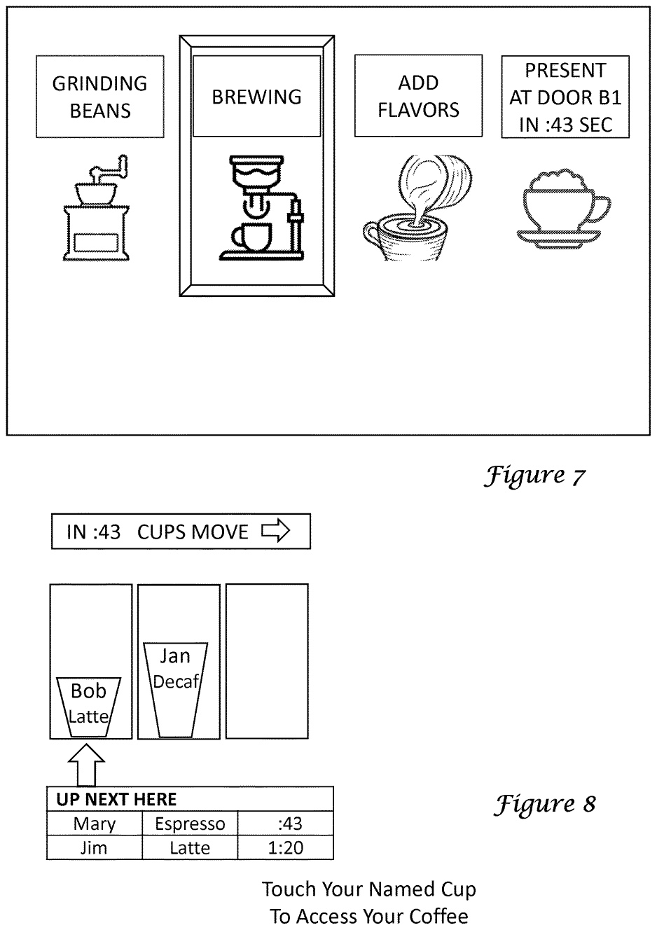

Customers can order beverages via ordering panel 123. Instead of using ordering panel 123, customers may also send beverage orders remotely via a mobile device (such as a mobile phone, a smartwatch, or a computer tablet), a desktop or laptop computer over the Internet. After an order has been placed by a customer, the beverage preparation process may begin. FIG. 7 illustrates an exemplary screen on progress display 121 showing the progress of a beverage order that is currently being prepared.

Front door 111 also includes a beverage pick-up station 141. For the present embodiment, pick-up station 141 includes three pick-up windows 141a-141c, each of which can be covered by a corresponding one of doors 41a-41c. Preferably, doors 41a-41c remain locked until a beverage is ready to be picked up by a customer. A customer may pick up his/her beverage at one of pick-up windows 141a-141c when its door is opened. Although FIG. 1 shows that pick-up station 141 has three pick-up windows, alternative embodiments may include more or fewer pick-up windows. A shelf 113 is located below pick-up station 141 on which a customer can place a first beverage before accessing a second beverage.

When a completed beverage is ready to be picked up, a customer can use ordering panel 123 to unlock one of doors 41a-41c. For example, ordering panel 123 can inform a customer to access his/her beverage by touching a graphical representation of its named cup displayed on ordering panel 123, and the corresponding one of doors 41a-41c will be opened for the customer to pick up the completed beverage. Alternatively, order progress display 121 can be utilized to inform a customer to access his/her beverage by touching a graphical representation of its named cup displayed on order progress display 121.

Each of pick-up windows 141a-141c is equipped with a sensor (not shown) to detect if a customer's hand is inside a pick-up window. The door of a pick-up window will not close when the customer's hand is detected to prevent the door from inadvertently closing on the customer's hand.

In addition to allowing a customer to open a door of a pick-up window, order progress display 121 also shows a queue of all pending beverage orders to allow customers to know how long it will take for their beverage to be ready for pick up. FIG. 8 is an exemplary screen showing an order queue and the customers' orders that are ready to be picked up at corresponding pick-up windows.

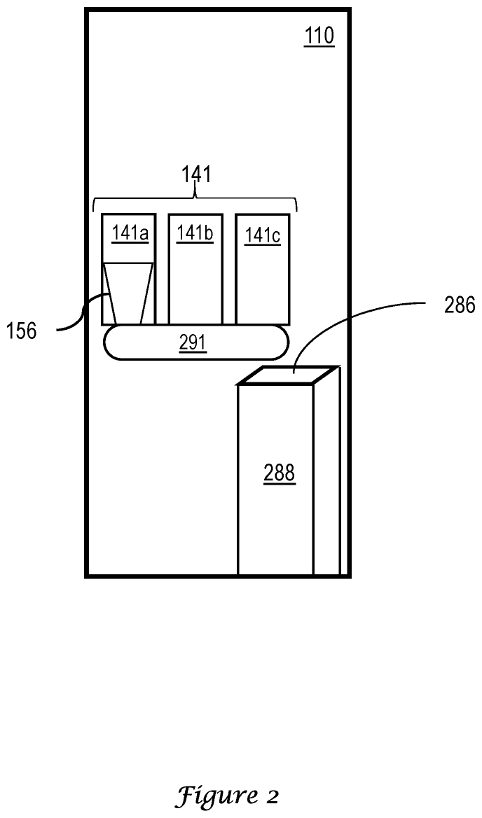

With reference now to FIG. 2, there is illustrated a conveyor for conveying completed beverages within housing 110. As shown, conveyor 291 is located below pick-up station 141. In addition, conveyor 291 is preferably attached to the back side of front door 111. Thus, conveyor 291 moves outside of housing 110 when front door 111 is opened. This allows for easier cleaning of the beverage dispensing and cup movement areas located within housing 110.

After the preparation of a beverage has been completed, the completed beverage will be placed on conveyor 291 at pick-up window 141a. At this time, order progress display 121 notifies a customer that his/her completed beverage is ready to be picked up. After the customer touches his/her name on the screen of the display, door 41a at pick-up window 141a will be opened so that the customer can pick up his/her completed beverage.

If the customer does not pick up his/her completed beverage at pick-up window 141a, conveyor 291 will move the completed beverage to pick-up window 141b. If the customer does not pick up his/her completed beverage at pick-up window 141b, conveyor 291 will move the completed beverage to pick-up window 141c. Conveyor 291 is designed to stop at three pick-up points to place the completed beverage at pick-up windows 141a-141c.

If the customer does not pick up the completed beverage at pick-up window 141c within an allotted amount of time, conveyor 291 will move the completed beverage forward to discard it from conveyor 291 into a disposal bin 288 provided near conveyor 291 via an opening 286. For example, a cup 156 with completed beverage that is located on conveyor 291 will be dropped off from conveyor 291 into disposal bin 288 through opening 286 after three stops. This will eliminate any potential “logjam” caused by completed beverages not picked up by customers on time.

The allotted time window for the customer to pick up his/her completed beverage after it is placed on conveyor 291 can be adjusted according to the preferences of food-service operators.

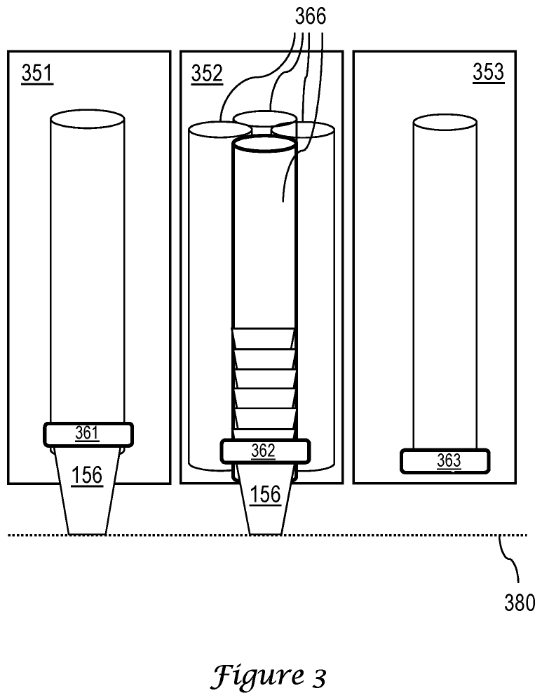

Referring now to FIG. 3, there are illustrated various cup turrets within housing 110 for dispensing cups to hold prepared beverages. For the present embodiment, housing 110 includes three cup turrets 351-353 that can be readily removable from and attachable to housing 110. Each of cup turrets 351-353 is able to hold about 100 cups. Each of cup turrets 351-353 dispenses cups 156 of a particular size, such as small, medium, or large. Housing 110 may include any number of cup turrets and any combination of sizes of cups based on the preferences of food-service operators.

Each of cup turrets 351-353 includes a set of vertical tubes 366 each of which contains a sleeve of cups of a particular size. As an example, cup turret 352 includes four vertical tubes 366. When all of the cups in a particular vertical tube 366 of a cup turret have been dispensed, the cup turret rotates until another sleeve of cups is positioned to drop into its corresponding one of cup dispensers 361-363.

The vertical distance between each of cup turrets 351-353 and its corresponding one of cup dispensers 361-363 varies, depending on the size of the cups contained in the cup turret to place the bottoms of cups 156 that are next to be dropped from each of cup dispensers 361-363 in a same horizontal plane 380 regardless of the size of cup 156. In this way, the distances that cups 156 drop from one of cup dispensers 361-363 to a cup-transfer mechanism (described below) within housing 110 are the same for each cup 156 regardless of cup size.

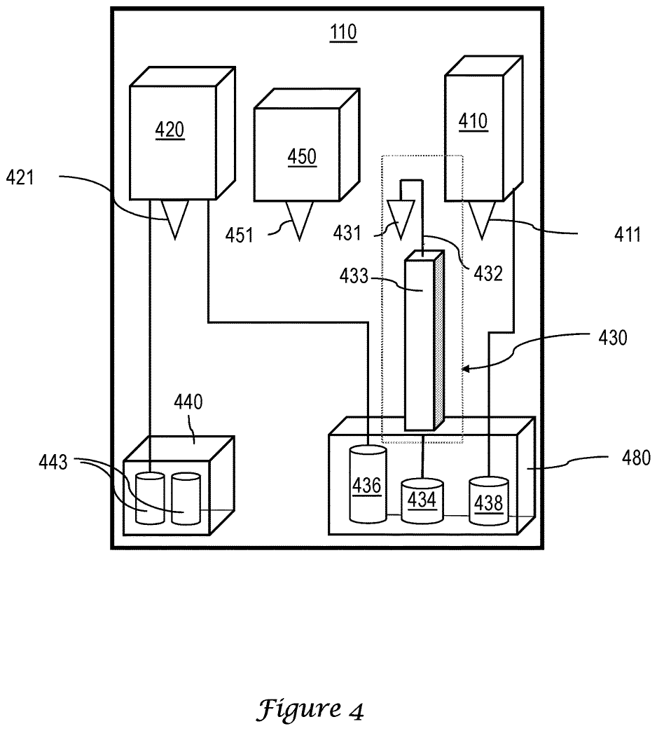

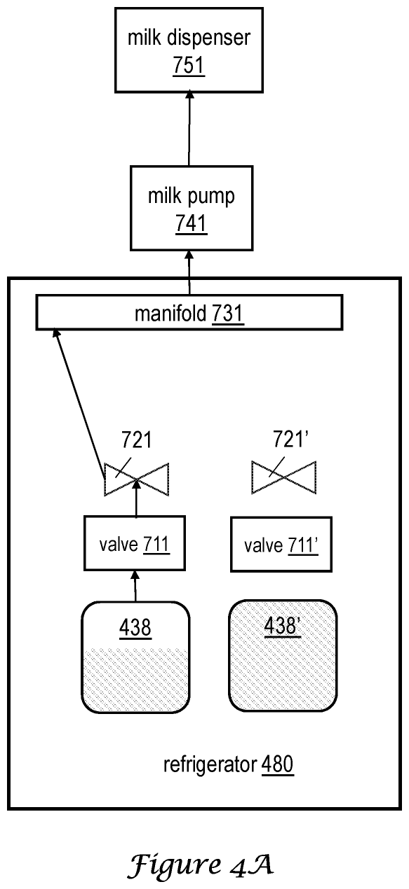

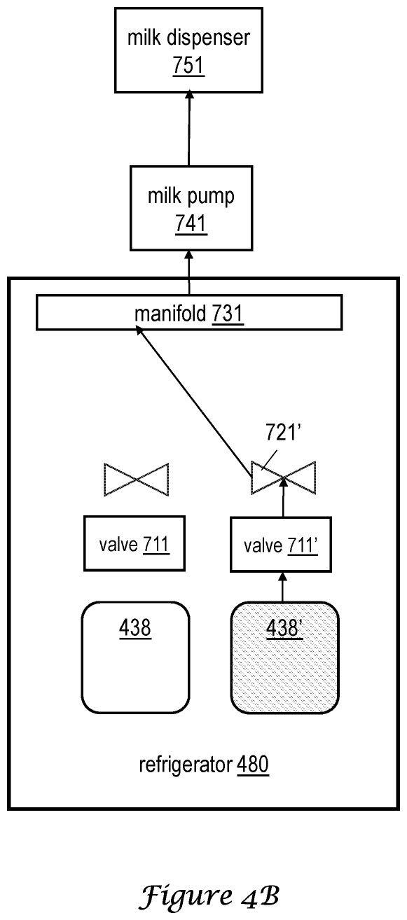

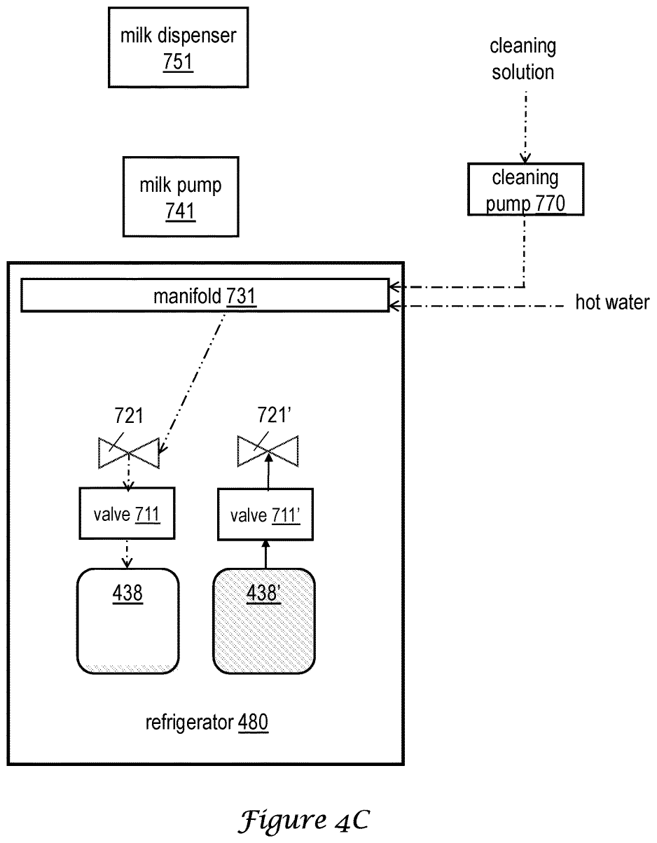

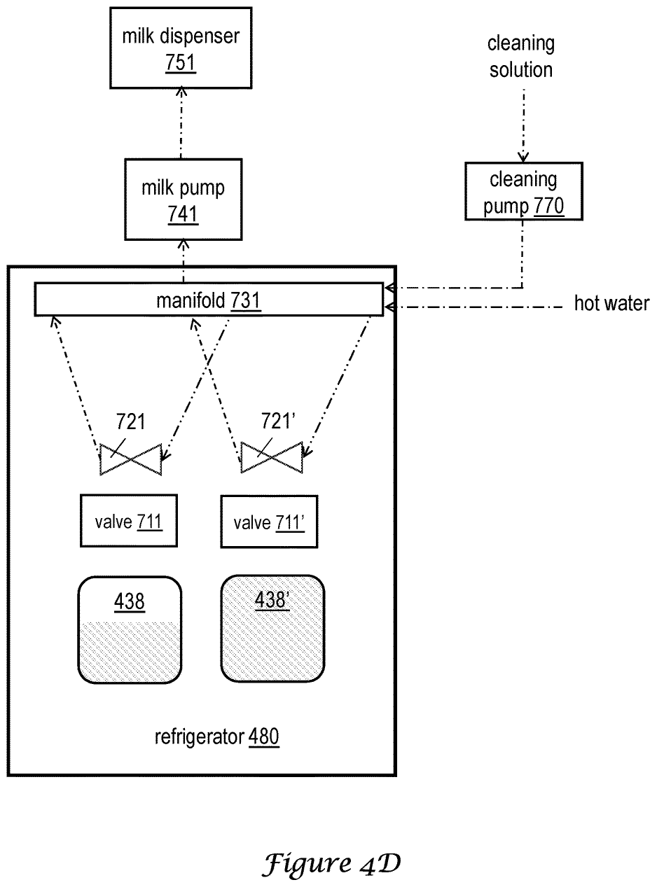

With reference now to FIG. 4, there is illustrated various beverage dispensing systems within housing 110. As shown, housing 110 includes a bean-to-cup coffee dispensing system 410, a specialty coffee dispensing system 420, and a cold brew and nitro coffee dispensing system 430. Bean-to-cup coffee dispensing system 410 is connected to a dispensing head 411, specialty coffee dispensing system 420 is connected to a dispensing head 421, and cold brew and nitro coffee dispensing system 430 is connected to a dispensing head 431. Housing 110 also includes an ice dispensing system 450 connected to a dispensing head 451. Coffee dispensing systems such as bean-to-cup coffee dispensing system 410, specialty coffee dispensing system 420, cold brew and nitro coffee dispensing system 430, and ice dispensing system 450 are well-known in the art and will not be discussed in detail.

Cold brew and nitro coffee dispensing system 430 includes cold-brew coffee concentrate stored in a reservoir 434 and a nitrogen source (not shown), both located in a refrigerator 480. Cold brew and nitro coffee dispensing system 430 also includes a cooling tower 433 for cooling a line 432 that passes cold-brew coffee coming out from reservoir 434. Before reaching dispensing head 431, nitrogen can be added to the cold-brew coffee to make nitrogen-infused cold-brew coffee based on a customer's selection.

A set of sensors (not shown) is provided within reservoirs 434, 436, and 438 to detect the amount of liquid stored inside reservoirs 434, 436, and 438. Sensors, such as resistive probes, optical sensors, and float switches, or various methods of measuring dispensed volumes since reservoirs 434, 436 and 438 were last replaced, are utilized to monitor if the fluid within reservoirs 434, 436, and 438 has dropped below a predetermined level and needs to be replenished or replaced. For example, a sensor can sense when the level of cold-brew coffee concentrate within reservoir 434 has dropped below a predetermined level, which means the cold-brew coffee concentrate in reservoir 434 needs to be replenished or replaced. Similarly, when the milk within reservoir 438 storing milk drops below a predetermined level, it means that milk needs to be replenished or replaced.

Other reservoirs contain “add-ins” to allow customers to choose to include in their beverage order. Such add-ins may include flavorings (chocolate, caramel, vanilla, sugar-free vanilla, hazelnut, and chai), milks (dairy and non-dairy), nitrogen gas (for nitro-infused cold brew coffee), ice, etc. For example, a flavor station 440 includes several bottles or bags-in-boxes (BIBs) 443 of add-ins. Level sensors (not shown) are also provided within flavor station 440 to detect the amount of add-ins stored inside various BIBs 443. When the add-in in a BIB has dropped below a predetermined level, it means that the add-ins in that BIB needs to be replenished or replaced.

Referring now to FIGS. 4A-4B, there are illustrated a milk dispensing system, according to one embodiment. In FIG. 4A, the milk dispensing system is shown to have two milk delivery channels, although more milk delivery channels can be added. The first milk delivery channel includes a reservoir 438, a valve 711, and a diverter 721. The second milk delivery channel includes a reservoir 438′, a valve 711′, and a diverter 721′. Reservoirs 438-438′, valves 711-711′, and diverters 721-721′ are located within refrigerator 480. For the present embodiment, refrigerator 480 can hold up to five one-gallon reservoirs (such as reservoirs 438 and 438′) of various types of dairy milks (such as whole milk, half-and-half, 2% milk, and skim milk) and/or non-dairy milks (such as soy milk, almond milk, and oat milk). With five separate milk delivery channels, five different types of dairy or non-dairy milks can be served.

During normal operations, only one milk delivery channel can be activated to draw milk from its associated reservoir. For example, as shown in FIG. 4A, only valve 711 and diverter 721 within the first milk delivery channel are activated to draw milk from reservoir 438. Diverter 721 may send milk to manifold 731. The milk in manifold 731 travels to milk pump 741 and then to milk dispenser 751.

If the milk in, for example, reservoir 438 has been completely depleted, then valve 711′ and diverter 721′ within the second milk delivery channel will be activated automatically (i.e., without human intervention) to draw milk from reservoir 438′, as shown FIG. 4B.

Before replacing reservoir 438 with a new reservoir containing milk, the milk lines between reservoir 438 and manifold 731 need to be cleaned via a two-step process. First step: a cleaning solution is sent to manifold 731 via a cleaning pump 770, as shown in FIG. 4C, and the cleaning fluid travels from manifold 731 to diverter 721 and to reservoir 438 via valve 711. Second step: hot water is sent to manifold 731, as shown in FIG. 4C, and the hot water travels from manifold 731 to diverter 721 and to reservoir 438 via valve 711. The first and second steps are performed automatically without any human intervention. At this point, the milk lines between manifold 731 and reservoir 438 are cleaned, and reservoir 438 (containing dirty fluids) is now ready to be replaced with a new reservoir containing the correct type of milk by an operator. The operator can perform the replacement of reservoir 438 at his/her convenience. When it comes time to perform reservoir replacement, the operator disconnects reservoir 438 at valve 711, and then connects a new reservoir at valve 711. Reservoir 438 may be discarded or recycled.

Every night, the milk lines between reservoirs 438-438′ and milk dispenser 751 need to be cleaned via a two-step process. First step: a cleaning solution is sent to manifold 731 via cleaning pump 770, as shown in FIG. 4D. The cleaning fluid travels from manifold 731 to diverters 721-721′, back to manifolds 731 and to milk pump 741 and milk dispenser 751. Second step: hot water is sent to manifold 731, as shown in FIG. 4D. The hot water travels from manifold 731 to diverters 721-721′, back to manifold 731, and to milk pump 741 and milk dispenser 751. The first and second steps are performed automatically without any human intervention. At this point, the milk lines between all reservoirs 438-438′ and milk dispenser 751 are cleaned, and the daily self-cleaning process is completed. Preferably, this self-cleaning process is performed at, for example, 1:00 a.m. every night.

The self-cleaning subsystem for the milk dispensing system can also be applied to clean the coffee lines, if necessary.

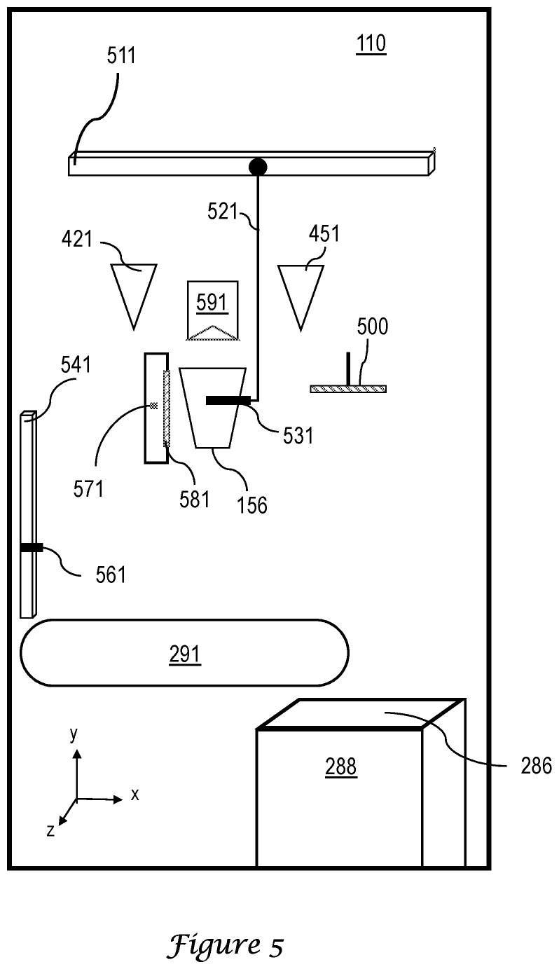

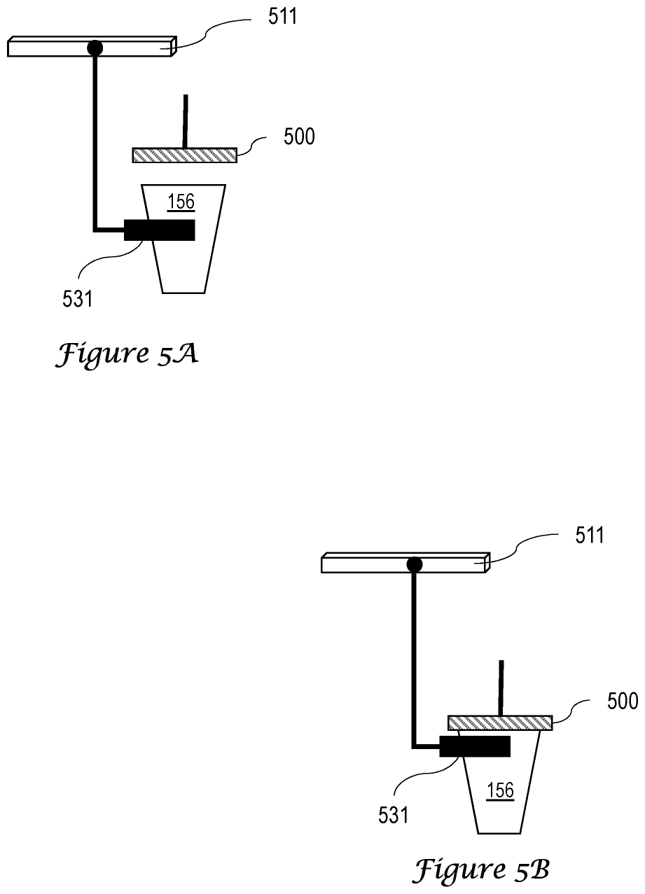

Referring now to FIG. 5, there are illustrated a first and second cup-transfer mechanisms for transporting beverage cups within housing 110. The purpose of the first cup-transfer mechanism is to fetch and transport beverage cups from one of cup dispensers 351-353 (from FIG. 3) to one of dispensing heads 411, 421, 431, 451 (from FIG. 4). As shown, the first cup-transfer mechanism includes a cup support 531 connected to a rail 511 via a telescopic rod 521. Cup support 531 is allowed to move only on an x-y plane of housing 110. Aligned along an x-axis of housing 110, rail 511 is located above dispensing heads 411, 421, 431, 451 in order to prevent rail 511 from getting any beverage spilling.

The purpose of the second cup-transfer mechanism is to transport cups with completed beverages from one of dispensing heads 411, 421, 431, 451 to pick-up station 141 (from FIG. 2) at which conveyer 291 is located. As shown, the second cup-transfer mechanism includes a cup support 561 connected to a rail 541. Rail 541 is located along the y-axis of housing 110. Cup support 561 is allowed to move only on a y-z plane of housing 110.

After cup support 531 has fetched a cup 156 from one of cup dispensers 351-353 (from FIG. 3), cup support 531 travels on the x-y plane of housing 110 to move cup 156 to a location below a plunger 500 at which point plunger 500 can push cup 156 slightly downward such that cup 156 is properly seated within cup support 531, as shown in FIGS. 5A-5B.

After cup 156 has been properly seated within cup support 531, cup support 531 then travels along rail 511 to move cup 156 to one of dispensing heads 411, 421, 431, 451 from which the appropriate coffee (and add-ins) for making the customer's beverage order can be dispensed into cup 156.

While beverage is being dispensed into cup 156, a laser engraver 571 begins to engrave marking information about the customer's beverage order onto cup 156. This marking information preferably takes the form of a barcode (or a QR code) that enables a cashier at the checkout to properly tally up the total cost of the customer's beverage by scanning the barcode at a point-of-sale (POS) system to identify the name of the beverage plus any add-ins (such as flavorings and sweeteners), instead of just charging the customer based only on the cup size.

For the present embodiment, laser engraver 571 is located in close proximity to dispensing heads 421, 451. Laser engraver 571 is protected by a splash guard 581 from beverage splashes that may occur when beverage is being dispensed into cup 156. Splash guard 581 is transparent to laser beams. In addition, an air curtain and/or a spritz of hot water can be delivered over splash guard 581 in order to clean any beverage spillage and/or particulates that have landed on splash guard 581.

In addition, an infrared camera 591 is utilized to verify various aspects of the beverage ordered by the customer, including the size of the cup that contains the completed beverage, the level of the beverage contained within the cup, and the approximate temperature of the beverage contained within the cup.

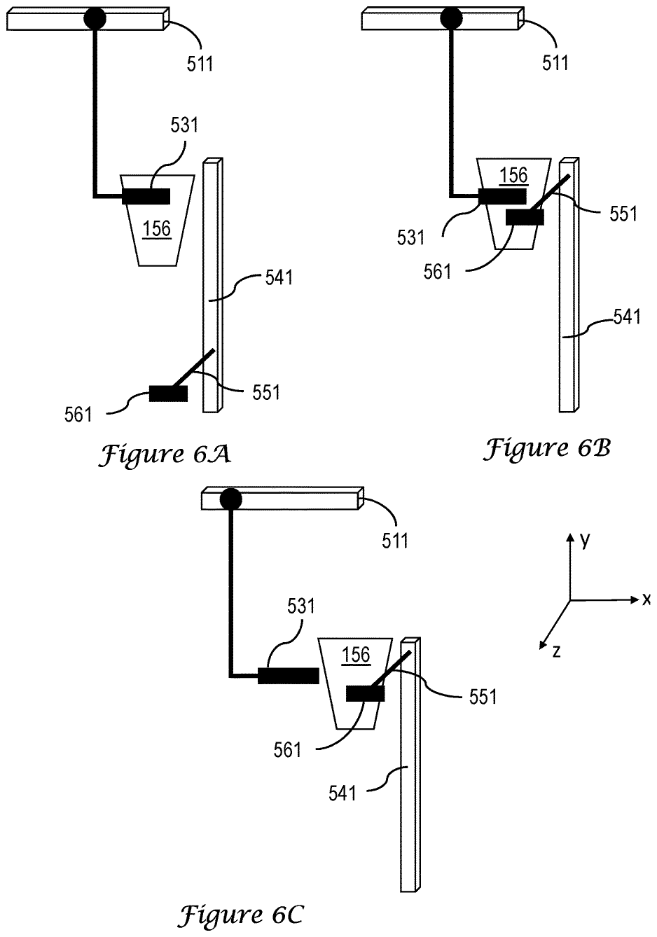

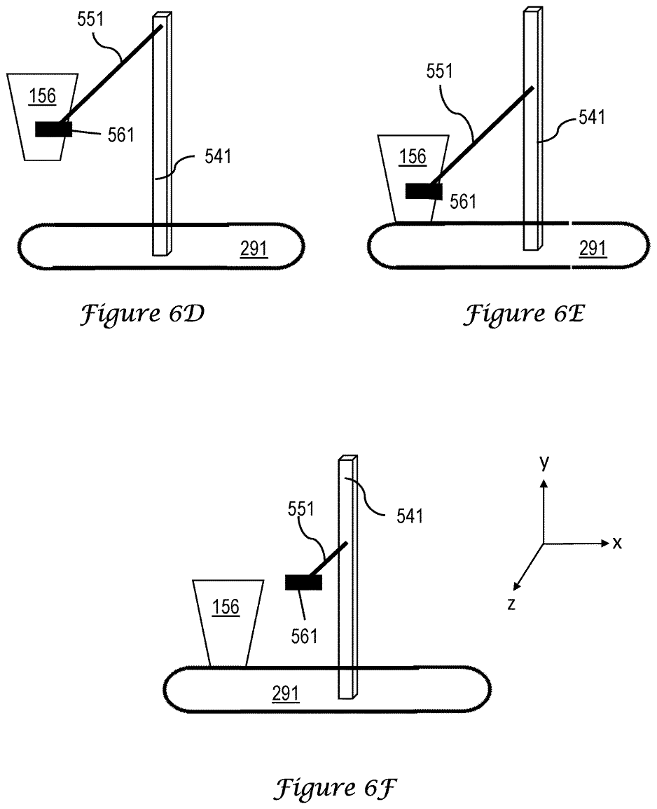

With reference now to FIG. 6A-6F, there are illustrated the transfer of a cup from the first cup transfer mechanism to the second cup transfer mechanism, and then to conveyer 291. Cup support 561 is designed to receive cup 156 with the completed beverage from cup support 531 of the first cup-transfer mechanism. Prior to receiving cup 156 from cup support 531, cup support 561 is positioned below cup support 531, as shown in FIG. 6A.

As shown, cup support 561 is connected to rail 541 via a telescopic rod 551 that can extend along the z-axis of housing 110. Specifically, telescopic rod 551 is orthogonally connected rail 541. The x, y, and z axes of housing 110 are mutually perpendicular to each other.

The size of cup support 561 is smaller than the size of cup support 531 so that cup support 561 engages cup 156 at a portion of cup 156 that is lower (and thus has a smaller diameter) than the portion of cup 156 that is engaged by cup support 531. When cup support 531 brings cup 156 with the completed beverage, cup support 561 travels upwardly along rail 541 until it receives cup 156 therein. Cup support 561 then continues to travel upwardly along rail 541 a little further until it lifts cup 156 out of cup support 531, as shown in FIG. 6B. After cup 156 has been secured within cup support 561, cup support 531 then moves away from cup support 561, as shown in FIG. 6C.

Following the transfer of cup 156 with the completed beverage from cup support 531 to cup support 561, cup support 561 and rod 551 move along rail 541 to approach conveyer 291, and rod 551 is then extended to move cup 156 towards conveyer 291, as shown in FIG. 6D. When cup support 561 reaches a predetermined position over conveyer 291, cup support 561 is lowered along rail 541 to place cup 156 on conveyor 291, as shown in FIG. 6E. Afterwards, cup support 575b retreats from conveyer 291, as shown in FIG. 6F.

As has been described, the present invention provides an apparatus for preparing and delivering custom-ordered caffeinated beverages.

While the invention has been particularly shown and described with reference to a preferred embodiment, it will be understood by those skilled in the art that various changes in form and detail may be made therein without departing from the spirit and scope of the invention.

What is claimed is:

1. An apparatus for preparing and delivering custom-ordered beverages, said apparatus comprising:
a housing having a plurality of cup dispensers;
a plurality of beverage dispensing systems, each having a dispensing head;
a first cup-transfer mechanism for transporting a cup from one of said cup dispensers to one of said dispensing heads to fill said cup with beverage;
a second cup-transfer mechanism for transporting said cup with filled beverage from one of said dispensing heads to a pick-up station;
a set of beverage pick-up windows located at said pick-up station;
a conveyer located at said pick-up station; and
a disposal bin, located near said conveyor, for receiving said cup of filled beverage if it has not been picked up by a customer.

2. The apparatus of claim 1, wherein said first cup-transfer mechanism includes
a first cup support connected to a first rail, wherein said first cup support only moves along an x-y plane of said housing; and
a second cup support connected to a first rail, wherein said second cup support only moves along said x-y plane of said housing.

3. The apparatus of claim 2, wherein said second cup-transfer mechanism includes
a third cup support connected to a third rail, wherein said third cup support only moves along an y-z plane of said housing, wherein said y-z plane is orthogonal to said x-y plane; and
a fourth cup support connected a fourth rail, wherein said fourth cup support only moves along said y-z plane of said housing.

4. The apparatus of claim 1, wherein said housing further includes a front door.

5. The apparatus of claim 4, wherein said set of beverage pick-up windows is located on said front door.

6. The apparatus of claim 4, wherein said conveyer is attached to the back side of said front door.

7. The apparatus of claim 1, wherein said set of beverage pick-up windows includes an automated door and a sensor for sensing a customer's hand to prevent said automated door closing on said customer's hand.

8. The apparatus of claim 1, wherein said conveyer moves said cup with filled beverage and stops to present it at each of said beverage pick-up windows.

9. The apparatus of claim 1, further comprising a laser engraver for engraving a marking information about said beverage ordered by said customer directly on said cup when said cup is being filled with beverage.

10. The apparatus of claim 9, wherein said laser engraver is protected by a splash guard that is cleaned by an air curtain.

11. The apparatus of claim 9, wherein said marking information is a barcode.

12. The apparatus of claim 1, further comprising an infrared camera to verify cup size, beverage level contained within said cup, and/or temperature of beverage contained within said cup.

13. The apparatus of claim 1, further comprising a plunger to ensure a cup is properly situated within a cup support within said first cup-transfer mechanism.

14. The apparatus of claim 1, further comprising a plurality of sensors for sensing whether or not the content stored in a container within said beverage dispensing system has been depleted.

15. The apparatus of claim 1, wherein said housing further includes a self-cleaning subsystem for automatically cleaning a plurality of milk lines located between a milk dispenser and a diverter without human intervention.

16. The apparatus of claim 15, wherein said self-cleaning subsystem automatically cleans said milk lines between a depleted reservoir and a valve for said depleted reservoir without human intervention.

17. The apparatus of claim 1, further comprising an order progress screen for informing customers regarding the progress of beverage preparations.

18. The apparatus of claim 1, further comprising an ordering panel for receiving beverage orders from customers.
